(19) United States
(12) Patent Application Publication
(10) Pub. No.: US 2015/0107249 A1
(43) Pub. Date: Apr. 23, 2015

(54) Extracting Heat From A Compressor System

(71) Applicants: Herman Artinian, Huntington Beach, CA (US); Parsa Mirmobin, La Mirada, CA (US)

(72) Inventors: Herman Artinian, Huntington Beach, CA (US); Parsa Mirmobin, La Mirada, CA (US)

(73) Assignee: Access Energy LLC, Cerritos, CA (US)

(21) Appl. No.: 14/059,727

(22) Filed: Oct. 22, 2013

(51) Int. Cl. F04D 29/58; F01K 27/02; F01K 7/16; F04D 1/04; F01D 15/10

(52) U.S. Cl. CPC F04D 29/5893; F04D 1/04; F01D 15/10; F01K 7/16; F01K 27/02; F05D 2260/20; F05D 2220/72; F05D 2220/76
USPC 60/645; 415/117; 60/643

(57) ABSTRACT

A system includes a gas compressor system and a thermal cycle. The gas compressor system includes a compressor housing defining an interior compressor chamber. A gas compressor is in the interior compressor chamber to compress gas received into interior compressor chamber. A heat exchange fluid passage is provided adjacent to a surface that contacts the gas being compressed by the gas compressor. The thermal cycle includes a working fluid heated using the heat exchange fluid passage of the compressor housing. The working fluid is expanded by the thermal cycle to generate electricity.

### BACKGROUND

The present disclosure pertains to extracting heat from a compressor system and heat sources for thermal cycles.

The state of the art technology in turbo machinery (hence compressors) has reached a maturity level where manufacturers are looking for fractional percent efficiency gains above their competitors, to a point where 0.1% efficiency is becoming a factor in awarding projects. This is also true for different types of compressors like screw, scroll or other. No manufacturer is able to provide a significant leap in efficiency of compressors, or products that integrate compressors such as turbochargers, compounders, fuel cells, etc.

### BRIEF DESCRIPTION OF THE DRAWINGS

FIG. 1A is a schematic diagram of an example thermal cycle.

FIG. 1B is a schematic diagram of an example Rankine Cycle system.

FIG. 1C is a schematic diagram of another example Rankine Cycle system like the system of FIG. 1B, except that it omits the evaporator heat exchanger.

FIG. 1D is a schematic diagram of another example Rankine Cycle system like the system of FIG. 1B, using a dual heat source.

FIG. 2 is a cross-sectional view of a centrifugal compressor having a heat collection flow channel.

Like reference numbers denote like components.

### DETAILED DESCRIPTION

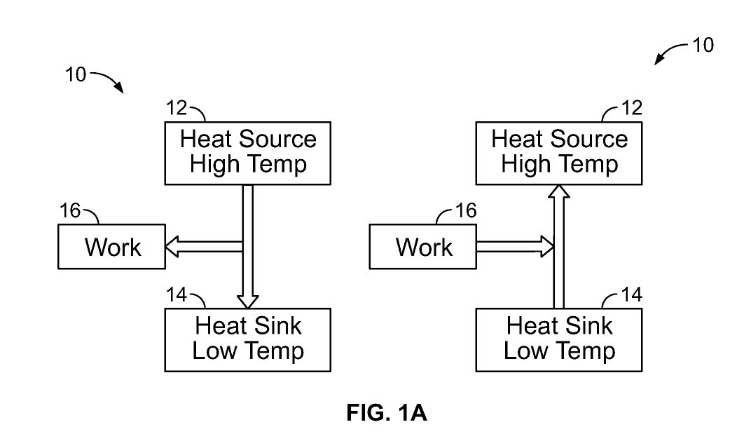

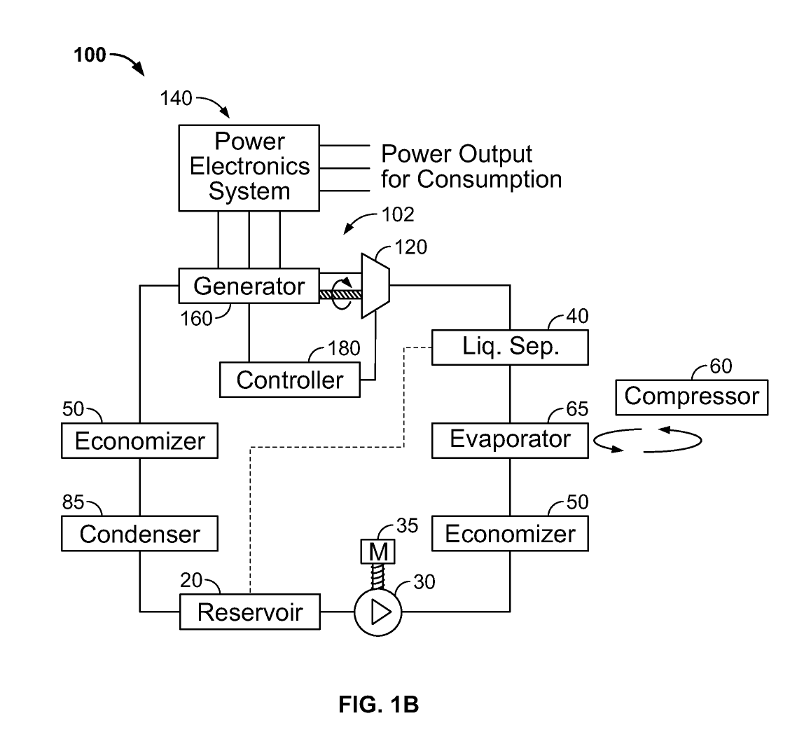

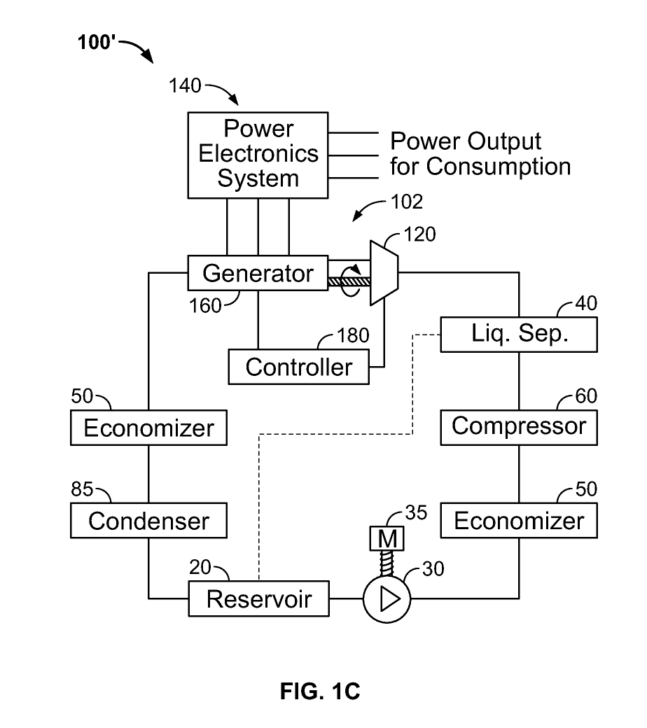

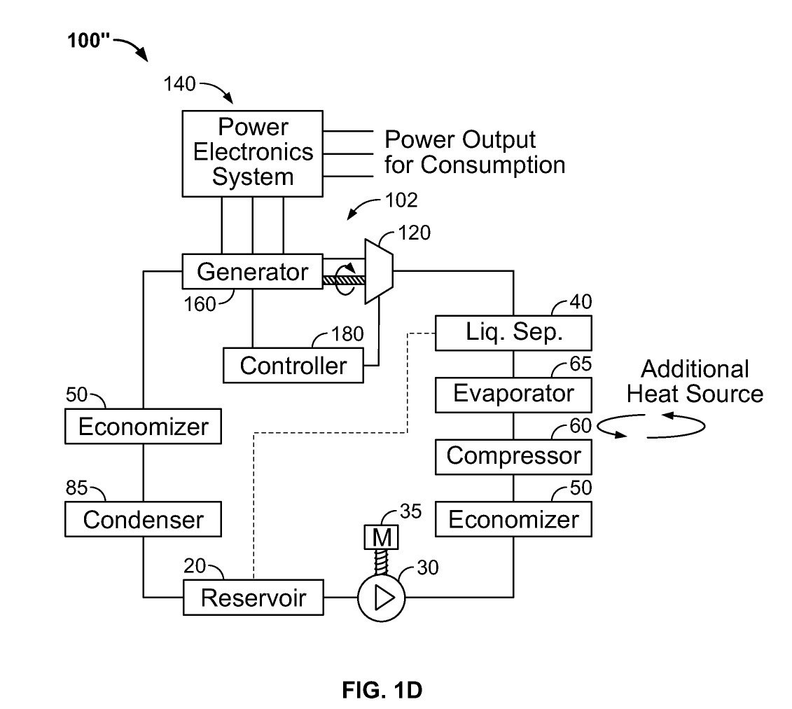

FIG. 1A is a schematic diagram of an example thermal cycle 10. The cycle includes a heat source 12 and a heat sink 14. The heat source temperature is greater than heat sink temperature. Flow of heat from the heat source 12 to heat sink 14 is accompanied by extraction of heat and/or work 16 from the system. Conversely, flow of heat from heat sink 14 to heat source 12 is achieved by application of heat and/or work 16 to the system. Extraction of heat from the heat source 12 or application of heat to heat sink 14 is achieved through a heat exchanging mechanism. Systems and apparatus described in this disclosure are applicable to any heat sink 14 or heat source 12 irrespective of the thermal cycle. For descriptive purposes, a Rankine Cycle (or Organic Rankine Cycle) is described by way of illustration, though it is understood that the Rankine Cycle is an example thermal cycle, and this disclosure contemplates other thermal cycles. Other thermal cycles within the scope of this disclosure include, but are not limited to, Sterling cycles, Brayton cycles, Kalina cycles, etc.

FIG. 1B is a schematic diagram of an example Rankine Cycle system 100 illustrating example system components. The Rankine Cycle 100 may be integrated into any waste heat recovery system. The Rankine Cycle 100 may be an Organic Rankine Cycle (“Rankine Cycle”), which uses an organic working fluid to receive waste heat from another process, such as, for example, from the heat source plant that the Rankine Cycle system components are integrated into. In certain instances, the working fluid may be a refrigerant (e.g., an HFC, CFC, HCFC, ammonia, water, R245fa, or other refrigerant). In some circumstances, the working fluid in thermal cycle 100 may include a high molecular mass organic fluid that is selected to efficiently receive heat from relatively low temperature heat sources. As such, a turbine generator apparatus 102 can be used to recover waste heat and to convert the recovered waste heat into electrical energy.

In certain instances, the turbine generator apparatus 102 includes a turbine expander 120 and a generator 160. The turbine generator apparatus 102 can be used to convert heat energy from a heat source into kinetic energy (e.g., rotation of the generator rotor), which is then converted into electrical energy. The turbine expander 120 is configured to receive heated and pressurized working fluid in a gaseous state, which causes the turbine expander 120 to rotate (and expand/cool the gas passing through the turbine expander 120). Turbine expander 120 is coupled to a rotor of generator 160 using, for example, a common shaft or a shaft connected by a gear box. The rotation of the turbine expander 120 causes the shaft to rotate, which in turn, causes the rotor of generator 160 to rotate. The rotor rotates within a stator to generate electrical power. In certain instances, the generator 160 is a permanent magnet rotor, synchronous generator with magnetic bearings. Other generator configurations, however, are within the concepts herein. The turbine generator apparatus 102 outputs electrical power that is configured by a power electronics package 140. The power electronics 140 can operate in conjunction with the generator 160 to provide power at fixed and/or variable voltages and fixed and/or variable frequencies. In certain instances, the power is 3-phase 60 Hz power at a voltage of about 400 VAC to about 480 VAC. Alternative embodiments may output electrical power at different power and/or voltages. Such electrical power can be transferred to electrical driven components within or outside the engine compressor system and, in certain instances, to an electrical power grid system after conversion. The turbine expander 120 may be an axial, radial, screw or other type turbine. The gas outlet from the turbine expander 120 may be coupled to the generator 160, which may receive the expanded gas from the turbine expander 120 to cool the generator components.

Rankine Cycle 100 includes a pump device 30 that pumps the working fluid. The pump device 30 is coupled to a liquid reservoir 20 that contains the working fluid, and a pump motor 35 can be used to operate the pump. The pump device 30 is used to convey the working fluid to the turbine expander 120 by way of an evaporator heat exchanger 65. The evaporator 65 may be any type of heat exchange device, such as, for example, a plate and frame heat exchanger, a shell and tube heat exchanger or other device. The evaporator 65 receives heat from a compressor system 60 of a companion process. In such circumstances, evaporator 65 includes a pass for the working fluid and a separate pass for a heat exchange fluid used to collect heat from the compressor system 60 via a heat exchange fluid passage of the compressor system 60 (discussed in more detail below). Some examples of the heat exchange fluid include water, steam, thermal oil, etc. FIG. 1C shows an alternative configuration of Rankine Cycle 100′, where the working fluid of the Rankine Cycle 100 is passed directly through the heat exchange fluid passage of the compressor system 60 to heat the working fluid directly. FIG. 1D shown another configuration of Rankine Cycle 100″, using both direct heating of the working fluid via the heat exchange fluid passage of the compressor system 60 and heating of the working fluid by an additional heat source via an evaporator 65. In any instance, the working fluid collects enough heat from the compressor system 60 so that at least a substantial portion of the working fluid is converted into gaseous state.

In certain instances, the Rankine Cycle 100 can be provided with an economizer heat exchanger 50 prior to the evaporator 65. Working fluid at a low temperature and high pressure liquid phase from the pump device 30 is circulated into one side of the economizer 50, while working fluid that has been expanded by the turbine expander 120 upstream of a condenser heat exchanger 85 is at a high temperature and low pressure vapor phase and is circulated into another side of the economizer 50 with the two sides being thermally coupled to facilitate heat transfer there between. Although illustrated as separate components, the economizer 50 (if used) is typically a single heat exchanger with passes for the working fluid output from the turbine expander 120 and working fluid output from the pump 30. The economizer 50 may be any type of heat exchange device, such as, for example, a plate and frame heat exchanger, a shell and tube heat exchanger or other device.

After being expanded by the turbine expander 120, the working fluid flows from the outlet of the turbine expander 120 (or outlet of the generator 160, if passed through the generator 160) to a condenser heat exchanger 85. The condenser 85 is a cool sink that removes heat from the working fluid so that all or a substantial portion of the working fluid is converted to a liquid state. In certain instances, a forced cooling airflow or water flow is provided over the condenser 85 to facilitate heat removal. After the working fluid exits the condenser 85, the working fluid may return to the liquid reservoir 20 where it is prepared to flow again though the Rankine Cycle 100.

Liquid separator 40 (if used) may be arranged upstream of the turbine generator apparatus 102 so as to separate and remove a substantial portion of any liquid state droplets or slugs of working fluid that might otherwise pass into the turbine generator apparatus 102. Accordingly, in certain instances of the embodiments, the gaseous state working fluid can be passed to the turbine generator apparatus 102, while a substantial portion of any liquid-state droplets or slugs are removed and returned to the liquid reservoir 20. In certain instances of the embodiments, a liquid separator may be located between turbine stages (e.g., between the first turbine wheel and the second turbine wheel, for multi-stage expanders) to remove liquid state droplets or slugs that may form from the expansion of the working fluid from the first turbine stage. This liquid separator may be in addition to the liquid separator located upstream of the turbine apparatus.

Controller 180 may provide operational controls for the various cycle components, including the heat exchangers, valves, the pump and the turbine generator.

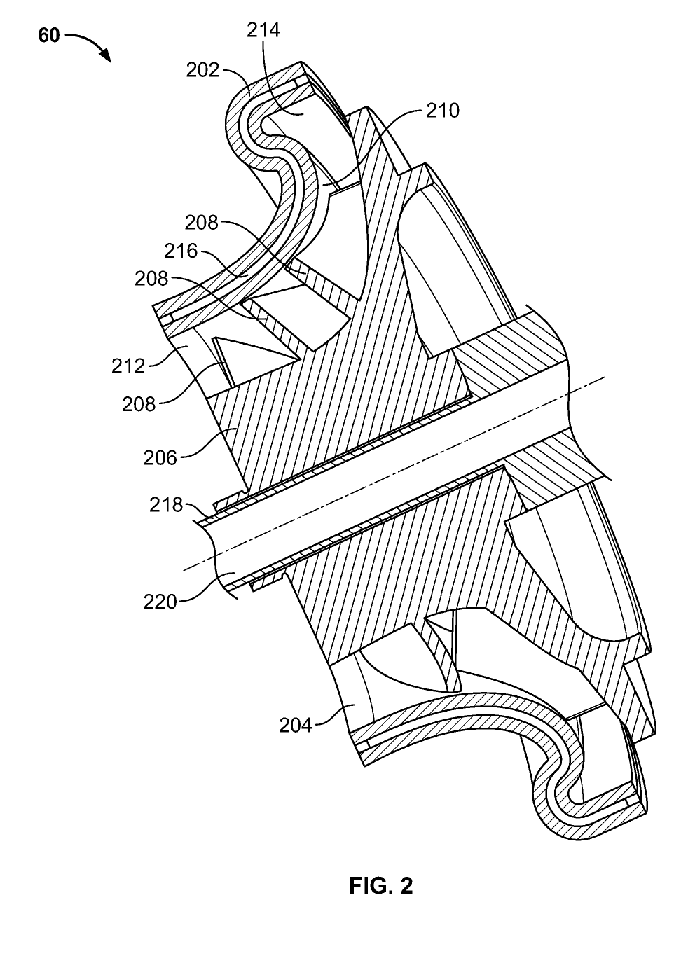

FIG. 2 shows a partial half-cross sectional view of a compressor system 60 of a companion process to the Rankine Cycle system 100. The compressor system 60 is a gas centrifugal type, having an annular housing 202 that defines an interior compressor chamber 204. The housing 202 encircles a centrifugal compressor wheel 206 enclosed in the compressor chamber 204. The compressor wheel 206 is carried to rotate on a rotational axis in the housing 202, and includes a plurality of radially upstanding blades 208 that pass closely to an inner wall 210 of the housing 202. The compressor wheel 206 receives gas of the companion process at an inlet 212 end of the compressor chamber 204 (near the left side of the view), and compresses the gas between the blades 206, the core of the wheel 204 and the inner wall 208 of the housing 202. The compressed gas is output at a radial outlet 214 (near the right side of the view).

Some portion of the work imparted to the gas by the compressor wheel 204 during compression is converted to heat. The inner wall 208 of the housing 202 is in continuous contact with the gas between the inlet 212 and the outlet 214 as the gas is being compressed, as the gas is partially compressed against the wall 208. Thus, the gas transfers its heat into the housing 202 via the inner wall 208, and a large portion of the heat transfer is conductive. The housing 202 is shown including a heat exchange fluid passage 216 running generally axially through housing 202, parallel to the rotational axis of the compressor wheel 204 and adjacent to the compressor chamber 204. Similarly, the compressor wheel 206 is carried to rotate on a shaft 218 and the shaft 218 is shown including a second heat exchange fluid passage 220, running generally axially through the shaft 218, parallel to the rotational axis of the compressor wheel 204. In either configuration, the heat exchange fluid passage 216, 220 can receive a flow of a heat exchange fluid to heat exchange with the gas being compressed to extract heat from the compressor system 60. In certain instances, the heat exchange fluid can be a dedicated fluid circulated through the compressor system 60, such as water, steam, thermal oil, etc., or the heat exchange fluid can be the working fluid of the companion thermal cycle system. In certain instances the heat exchange fluid and/or its conditions can be selected so that the fluid evaporates from the heat extracted from the compressor system 60.

The heat exchange fluid passages 216, 220 are arranged to achieve efficient heat transfer from the gas being compressed to fluid in the passages. Thus, the passage 216 extends generally axially in the housing, and radially outward and parallel to the inner wall 208 of the compressor chamber 204 which closely follows the outer profile of the compressor wheel 206. The passage 216 is adjacent the gas being compressed, with only a thin portion of the housing wall between the gas being compressed chamber 204 and the passage 216. This thin portion of the housing wall is in contact with the gas being compressed for efficient conductive heat transfer between the gas and fluid in the passage 216. In certain instances, the passage 216 is adjacent to the compressor chamber 204 the length (substantially or entirely) of the chamber 204, from the inlet 212 and the outlet 214. In other instances, the passage 216 can span less of the housing 202. In one example, the passage 216 is consolidated around the diffuser section of the compressor housing 202. As the housing 202 is annular, in certain instances, the fluid passage 216 can also be annular, encircling the entire circumference of the compressor chamber 204. In other instances, one or more circumferentially narrow fluid passages 216 (e.g., bores, slots and/or other shapes) can be provided that encircle less than the entire circumference of the compressor chamber 204.

The passage 220 in the shaft 218 runs axially through the center of the compressor wheel 204 and is also adjacent the gas being compressed. The passage 220 spans the compressor chamber 204. Only a thin portion of the shaft 218 wall and the body of the compressor wheel 206 are between the gas being compressed in the chamber 204 and the fluid in the passage 220. Heat conductively absorbed by compressor wheel 206 in contact with the gas being compressed is conductively transferred to the passage 220 for efficient heat transfer. Additionally, the fluid in the passage 220 extracts frictional heat generated by contact of the shaft 218 with the interior of the compressor wheel 206 when the compressor wheel 206 is rotated.

The extracted heat in the heat exchange fluid can be used to heat the working fluid of the companion thermal cycle (e.g., Rankine Cycle 100) or the working fluid of the thermal cycle (e.g., Rankine Cycle 100′) can be the heat exchange fluid and heated directly by being circulated through the compressor system 60. In the case of the heat exchange fluid heating the working fluid, the heat exchange fluid circulated through the fluid passage 216 to collect heat from the compressor system 60 and through a heat exchanger (e.g., evaporator 65) that transfers heat in the heat exchange fluid to the working fluid of the thermal cycle, for example, to vaporize or aid in vaporizing the working fluid. In the case of the working fluid being heated directly, the heat exchange fluid passage 216 is plumbed in-line into the thermal cycle, so that the working fluid circulates through the heat exchange fluid passage 216 as part of the cycle, for example, to vaporize or aid in vaporizing the working fluid. In certain instances, the heat extracted from the compressor 60 can supplement heat from another source (e.g., Rankine Cycle 100″). In any instance, one or more pumps may be provided in communication with the fluid passage 216 to assist in circulating the fluid.

Although discussed above in connection with a compressor system 60 of a centrifugal type, the concepts herein could be applied to other configurations of compressors. For example, the housing of an axial, screw, barrel or other type compressor can have a heat exchange fluid passage through the housing adjacent one or more of its compressors. In any type of compressor system 60, if the system has more than one stage, housings for one or more of the stages can include a heat exchange fluid passage. In certain instances, the outlet of a heat exchange fluid passage of one compressor or stage can be coupled to the inlet of a heat exchange fluid passage of another compressor or stage, so that the heat exchange fluid flows serially through the passages. Alternately, the heat exchange fluid passages of multiple compressor or stages can be separate, so that separate flows of heat exchange fluid circulate through and extract heat from the compressors or stages in parallel.

According to the concepts herein, it is possible to increase the efficiency of a compressor system by cooling gas being compressed as it is being compressed or close to the exit of the compressor. The concepts herein introduce evaporative cooling to the compressor housing that can increase the compression efficiency directly. Furthermore, by utilizing the compressor housing as an evaporator or to heat an evaporator of a thermal cycle, the thermal cycle system can convert this heat energy into electric energy. By comparison, convention removal of heat from a compressor system, by intercoolers, wastes the energy of the extracted heat or may require additional energy (e.g., fans, chillers, and the like) to operate.

A number of embodiments have been described. Nevertheless, it will be understood that various modifications may be made. Accordingly, other embodiments are within the scope of the following claims:

What is claimed is:

1. A system, comprising:
a gas compressor system, comprising:
a compressor housing defining an interior compressor chamber,
a gas compressor in the interior compressor chamber adapted to receive and compress gas,
a heat exchange fluid passage adjacent to a surface that contacts gas in the gas compressor;
a thermal cycle comprising a working fluid and a turbine coupled to an electrical generator, the turbine adapted to receive and expand the working fluid to drive the generator, and the working fluid heated using the heat exchange fluid passage of the gas compressor system.

2. The system of claim 1, where the compressor housing defines the heat exchange fluid passage adjacent to and extending substantially the length of the interior compressor chamber.

3. The system of claim 1, where the gas compressor defines the heat exchange fluid passage through a center of the gas compressor.

4. The system of claim 1, where the thermal cycle is coupled to the gas compressor to communicate the working fluid through the heat exchange fluid passage.

5. The system of claim 1, where the thermal cycle comprises a heat exchanger having a first pass in fluid communication with the turbine and a second, separate pass in fluid communication with the heat exchange fluid passage.

6. The system of claim 1, where the thermal cycle is an Organic Rankine Cycle, comprising an evaporator heat exchanger that supplies heat to the working fluid using the heat exchange fluid passage of the compressor housing, a compressor, the turbine, a condenser heat exchanger that extracts heat from the working fluid, and a liquid pump.

7. The system of claim 1, where the heat exchange fluid passage extends generally axially along a rotational axis of compressor, from an inlet to the chamber to an outlet to the chamber.

8. The system of claim 7, where the heat exchange fluid passage is adapted to place heat exchange fluid in the passage in conductive heat transfer with gas being compressed in the compressor chamber.

9. The system of claim 7, comprising only a wall of the interior compressor chamber between the heat exchange fluid passage and the gas compressor.

10. The system of claim 1, where the gas compressor is carried to rotate on a rotational axis and the heat exchange fluid passage extends substantially in the direction of the rotational axis substantially parallel to the outer profile of the gas compressor.

11. The system of claim 10, where the heat exchange fluid passage is radially outward from the rotational axis.

12. The system of claim 1, where the gas compressor comprises a centrifugal compressor wheel that compresses gas received at gas inlet against a wall of the interior compressor chamber.

13. A method, comprising:
flowing a heat exchange fluid through a heat exchange fluid passage in a gas compressor system while compressing gas in the gas compressor system, the heat exchange fluid passage adjacent to a surface that contacts gas being compressed;
extracting heat from the gas being compressed with the heat exchange fluid; and
operating a turbine of a thermal cycle at least in part using the extracted heat to drive an electrical generator.

14. The method of claim 13, where the heat exchange fluid passage is in a compressor housing of a compressor system, and adjacent and extending substantially the length of a chamber containing a compressor.

15. The method of claim 13, where the heat exchange fluid passage is in a compressor of the gas compressor system.

16. The method of claim 13, where the fluid comprises a working fluid of the thermal cycle, and
where operating the turbine comprises expanding the heated working fluid in the turbine.

17. The method of claim 13, where the fluid comprises a heat exchange fluid, and the method comprises:
passing the heated heat exchange fluid through an evaporator heat exchanger of the thermal cycle to heat a working fluid of the thermal cycle.

18. The method of claim 13, where extracting heat from the gas being compressed comprises conductive transferring heat from the gas being compressed to the compressor housing and to the fluid passed through the heat exchange passage.

19. A system, comprising:
a compressor in a housing; and
a heat exchange fluid passage extending adjacent and substantially the length of an interior compressor chamber.

20. The system of claim 19, where the heat exchange fluid passage is defined in the housing or defined in the compressor.

21. The system of claim 19, comprising a thermal cycle comprising a working fluid and a turbine coupled to an electrical generator, the turbine adapted to receive and expand the working fluid to drive the generator, and the working fluid heated using the heat exchange fluid passage of the compressor housing.

22. The system of claim 21, where the thermal cycle is coupled to the housing to communicate the working fluid through the heat exchange fluid passage.

23. The system of claim 21, where the thermal cycle comprises a heat exchanger having a first pass in fluid communication with the turbine and a second, separate pass in fluid communication with the heat exchange fluid passage.
